(19) United States
(12) Patent Application Publication
(10) Pub. No.: US 2013/0271399 A1
(43) Pub. Date: Oct. 17, 2013

(54) ELECTROMAGNETIC TOUCH DEVICE

(71) Applicant: KYE SYSTEMS CORP., New Taipei City (TW)

(72) Inventor: Chih-Min LIU, New Taipei (TW)

(73) Assignee: KYE SYSTEMS CORP., New Taipei City (TW)

(21) Appl. No.: 13/803,930

(22) Filed: Mar. 14, 2013

(30) Foreign Application Priority Data
Apr. 11, 2012 (TW) 101112874

(51) Int. Cl. G06F 3/041

(52) U.S. Cl. CPC G06F 3/041
USPC 345/173

(57) ABSTRACT

An electromagnetic touch device is adapted to cooperate with a signal generation unit. The electromagnetic touch device includes a sensing unit and a control unit. The sensing unit includes a plurality of antenna modules which form a sensing zone, are adjacent to each other, do not overlap, and receive an electromagnetic signal generated by the signal generating unit, to generate a plurality of electromagnetic sensing signals. The control unit coupled to the antenna modules receives the electromagnetic induction signals and calculates a location of the signal generating unit in the sensing zone according to intensities of the electromagnetic sensing signals.

### CROSS-REFERENCE TO RELATED APPLICATIONS

This non-provisional application claims priority under 35 U.S.C. §119(a) on Patent Application No(s). 101112874 filed in Taiwan, R.O.C. on Apr. 11, 2012, the entire contents of which are hereby incorporated by reference.

### BACKGROUND

1. Technical Field

The disclosure relates to a touch device, more particularly to an electromagnetic touch device.

2. Related Art

Touch panels are widely used in the daily life now. Touch panels are used easily and have higher interactive services, so they are widely accepted by consumers, and are applied to electronic devices, for example, mobile phones, notebooks, and tablet personal computers. Touch panels can approximately be classified into a resistor type, a capacitor type, an optical type, a sonic type and en electromagnetic type. An electromagnetic touch panel mainly includes a digital sensor board, a controller board and an electromagnetic pen.

In the digital sensor board, there are circuits in an X-axis and a Y-axis, and the circuits in the X-axis and the Y-axis cross each other. When the electromagnetic pen approaches the touch panel, the magnetic field on the digital sensor board will be changed. Herein, the electromagnetic touch panel can calculate a location of the electromagnetic pen, where a touch event occurs, according to the magnetic flux variation.

Accordingly, Taiwan R.O.C. Patent No. 1336973 provides a sensor board structure for increasing the size of a digital sensor board. However, in this sensor board structure, two adjacent sensor modules in an X-axis or a Y-axis overlap. This causes sensor modules to have to be disposed at different layers, so that the costs of the electromagnetic touch panel are increased.

### SUMMARY

An electromagnetic touch device according to an embodiment of the disclosure, adapted to cooperate with a signal generation unit. The electromagnetic touch device includes a sensing unit and a control unit. The sensing unit includes a plurality of antenna modules, which form a sensing zone, are adjacent to each other, do not overlap, and receive an electromagnetic signal generated by the signal generation unit, so as to generate a plurality of electromagnetic sensing signals. The control unit is coupled to the antenna modules. The control unit receives the electromagnetic sensing signals, and according to intensities of the electromagnetic sensing signals, calculates a location of the signal generation unit in the sensing zone.

In an embodiment, the antenna modules are antenna coils.

In an embodiment, the antenna modules are made of Indium Tin Oxide (ITO).

In an embodiment, the control unit includes a switch unit, an operation amplifier and a microcontroller. The switch unit is coupled to an antenna module. The switch unit is successively coupled to the antenna modules according to the control signal, so as to output the corresponding electromagnetic sensing signals. The operation amplifier is coupled to the switch unit, and receives and amplifies the electromagnetic sensing signals to generate the amplified electromagnetic signals. The microcontroller is coupled to the operation amplifier, generates the control signal, and receives the amplified electromagnetic signals to calculate the location of the signal generation unit in the sensing zone.

In an embodiment, the antenna modules are arranged as a matrix to form the sensing zone.

In an embodiment, a quantity of the antenna modules in a horizontal direction is the same as a quantity of the antenna modules in a vertical direction.

In an embodiment, a quantity of the antenna modules in a horizontal direction is different from a quantity of the antenna modules in a vertical direction.

An electromagnetic touch device according to another embodiment of the disclosure is adapted to a signal generation unit. The electromagnetic touch device includes a sensing unit and a control unit. The sensing unit includes a plurality of enclosed antenna modules. The enclosed antenna modules form a sensing zone, are adjacent to each other, and do not overlap. The enclosed antenna modules receive an electromagnetic signal generated by the signal generation unit to form a plurality of electromagnetic sensing signals. The control unit is coupled to the enclosed antenna modules, receives the electromagnetic sensing signals, and according to intensities of the electromagnetic sensing signals, calculates a location of the signal generation unit in the sensing zone.

### BRIEF DESCRIPTION OF THE DRAWINGS

The disclosure will become more fully understood from the detailed description given herein below for illustration only, thus does not limit the disclosure, wherein:

FIG. 1 is a schematic diagram of an electromagnetic touch device of the disclosure;

FIG. 2 is a schematic diagram of a switch unit according to an embodiment of the disclosure;

FIG. 3 is an arrangement schematic diagram of antenna modules in the sensing unit according to an embodiment of the disclosure; and

FIG. 4 is an arrangement schematic diagram of antenna modules in the sensing unit according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

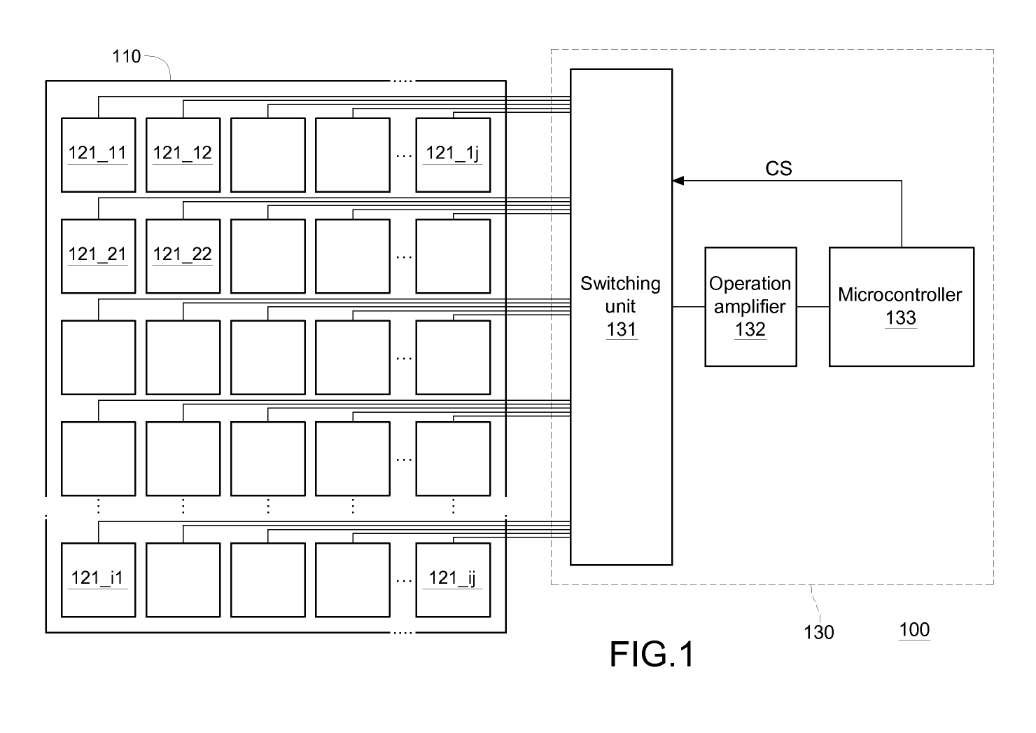

FIG. 1 is a schematic diagram of an electromagnetic touch device of the disclosure. The electromagnetic touch device 100 is adapted to cooperate with a signal generation unit. The signal generation unit can be, for example, an electromagnetic pen, for generating electromagnetic signals. The electromagnetic touch device 100 can be an input device, for example, a hand-writing panel.

The electromagnetic touch device 100 includes a sensing unit 110 and a control unit 130. The sensing unit 110 includes a plurality of antenna modules 121_11 to 122_ij, and i and j are positive integers greater than 1. The antenna modules 121_11 to 122_ij are arranged as, for example, a matrix, to form a sensing zone. The antenna modules 121_11 to 122_ij are adjacent to each other and do not overlap. In other words, the antenna modules 121_11 to 122_ij are adjacent to each other, every two adjacent ones of the antenna modules 121_11 to 122_ij have a corresponding preset distance therebetween, and the antenna modules 121_11 to 122_ij are not coupled to each other.

When the signal generation unit approaches the sensing zone, the antenna modules 121_11 to 122_ij receive an electromagnetic signal generated by the signal generation unit. Because the magnetic flux is changed, the antenna modules 121_11 to 122_ij generate a plurality of electromagnetic sensing signals. In this embodiment, the antenna modules 121_11 to 122_ij can be antenna coils.

Specifically, the antenna coil can be an enclosed antenna coil such as a square antenna coil or a rhombus antenna coil. Thus, the antenna modules 121_11 to 122_ij can be enclosed antenna modules. The antenna modules 121_11 to 122_ij are made of, for example, Indium Tin Oxide (ITO), and are made with a printing manner or an etching manner.

The control unit 130 is coupled to the sensing unit 110, receives the electromagnetic sensing signals generated by the antenna modules 121_11 to 122_ij, and according to the intensities of the electromagnetic sensing signals, calculates a location of the signal generation unit in the sensing zone. Subsequently, the control unit 130 transmits the position information to a subsequent application device, e.g. a computer, so that the subsequent application device can perform a corresponding operation.

Specifically, the control unit 130 includes a switch unit 131, an operation amplifier 132 and a microcontroller 133. The switch unit 131 is coupled to the antenna modules 121_11 to 122_ij. According to a control signal CS generated by the microcontroller 133, the control unit 130 is successively coupled to the antenna modules 121_11 to 122_ij, so as to output the corresponding electromagnetic sensing signal.

In an embodiment, the switch unit 131 can be a multiplexer, which can be successively coupled to the antenna modules 121_11 to 122_ij according to the control signal CS, so as to output the corresponding electromagnetic sensing signal. For example, when the switch unit 131 is coupled to the antenna module 121_11 according to the control signal CS, the switch unit 131 outputs the electromagnetic sensing signal corresponding to the antenna module 121_11. When the switch unit 131 is coupled to the antenna module 121_12 according to the control signal CS, the switch unit 131 outputs the electromagnetic sensing signal corresponding to the antenna module 121_12. The rest can be deduced accordingly.

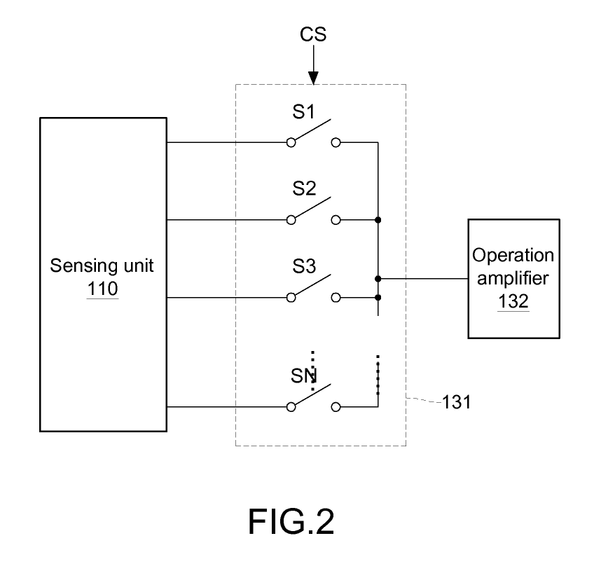

In another embodiment, the switch unit 131 can include a plurality of switches S1 to SN as shown in FIG. 2, and N=i×j, that is, a quantity of switches corresponds to a quantity of antenna modules. For example, the switches S1 to SN can be coupled to the antenna modules 121_11 to 122_ij one by one. For example, the switch S1 is coupled to the antenna module 121_11, the switch S2 is coupled to the antenna module 121_12, the switch SN is coupled to the antenna module 121_ij, and the rest can be deduced accordingly.

The switches S1 to SN are successively turned on according to the control signal CS, so that the operation amplifier 132 is switched to be coupled to the antenna modules 121_11 to 122_ij correspondingly. Herein, the corresponding electromagnetic sensing signal can be outputted to the operation amplifier 132 through one of the switches S1 to SN.

For example, when the switch S1 is turned on according to the control signal CS, the operation amplifier 132 is switched to be coupled to the antenna module 121_11. Herein, the electromagnetic sensing signal generated by the antenna module 121_11 is outputted to the operation amplifier 132 through the switch S1. When the switch S2 is turned on according to the control signal CS, the operation amplifier 132 is switched to be coupled to the antenna module 121_12. Herein, the electromagnetic sensing signal generated by the antenna module 121_12 is outputted to the operation amplifier 132 through the switch S2. The rest can be deduced accordingly.

The operation amplifier 132 is coupled to the switch unit 131 to successively receive the electromagnetic sensing signals outputted by the switch unit 131, and to amplify the electromagnetic sensing signal for subsequent processing. The microcontroller 133 generates the control signal CS by which the switch unit 131 switches the operation amplifier 132 to be coupled to each of the antenna modules 121_11 to 122_ij. Thus, the control unit 130 can acquire the electromagnetic sensing signal generated by each of the antenna modules 121_11 to 122_ij, in a scanning manner. The microcontroller 133 is coupled to the operation amplifier 132 to receive the electromagnetic sensing signals amplified by the operation amplifier 132. Thus, the microcontroller 133 calculates the location of the signal generation unit in the sensing zone according to the intensities of the electromagnetic sensing signals. Subsequently, the microcontroller 133 transmits such position information to subsequent application devices, so that the subsequent application devices can perform corresponding operations.

In this embodiment, the intensity of the electromagnetic sensing signal generated by each of the antenna modules 121_11 to 122_ij is associated with the distance between the signal generation unit and the sensing zone. For example, when the signal generation unit approaches the antenna module 121_11 of the sensing zone, the intensity of the electromagnetic sensing signal generated by the antenna module 121_11 is stronger. Herein, the antenna module 121_ij is farther from the signal generation unit than the antenna module 121_11, so that the intensity of the electromagnetic sensing signal generated by the antenna module 121_ij is weaker or zero. In this way, the control unit 130 can calculate the location of the antenna module 121_11 of the sensing zone, where the signal generation unit approaches, through the intensity of electromagnetic sensing signal.

On the other hand, when the intensities of the electromagnetic sensing signals generated by the antenna modules 121_11 and 121_21 are similar, the control unit 130 can learn that the location of the signal generation unit in the sensing zone is between the antenna modules 121_11 and 121_21. The rest can be deduced accordingly. In this way, the electromagnetic touch device 100 can determine the location of the signal generation unit in the sensing zone of the sensing unit 110 through the intensity relation among the electromagnetic sensing signals, thereby being used more conveniently.

In the sensing unit 110, the antenna modules 121_11 to 122_ij, which are adjacent to each other and do not overlap, form the sensing zone, so that the antenna modules 121_11 to 122_ij can be disposed on the same layer. In this way, the electromagnetic touch device may be designed easily, and the costs may be reduced.

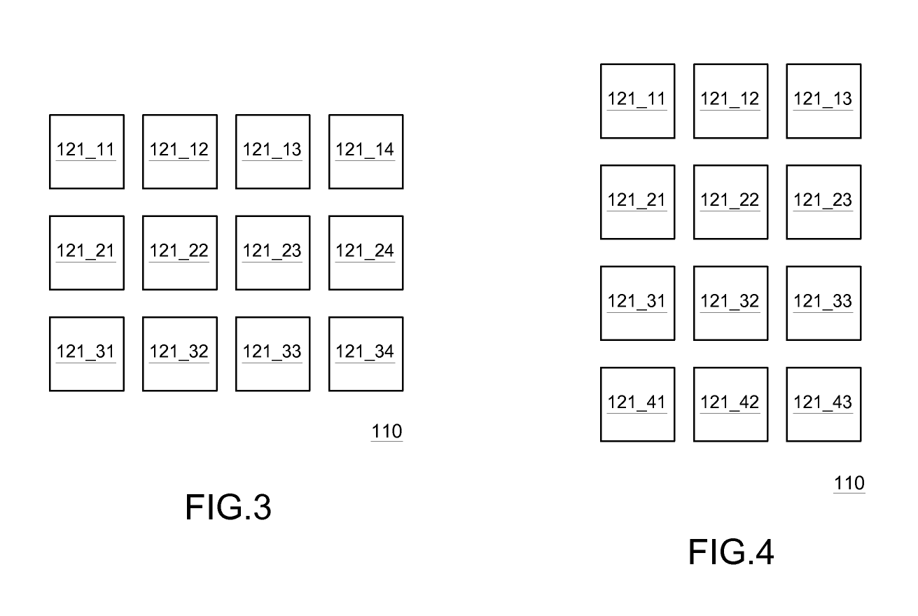

In this embodiment, a quantity of the antenna modules in the horizontal direction is the same as a quantity of the antenna modules in the vertical direction, that is, i=j. Herein, the shape of the sensing zone of the sensing unit 110 is square. In some embodiments, a quantity of the antenna modules in the horizontal direction is different from that in the vertical direction, for example, i<j or i>j. In an example as shown in FIG. 3, i=3, j=4, and then i<j. In another example as shown in FIG. 4, i=4, j=3, and then i>j. Herein, the shape of the sensing zone of the sensing unit 110 is rectangular. In this way, the shape of the electromagnetic touch device 100 can be designed variously.

For the electromagnetic touch device in the disclosure, a plurality of antenna modules in the sensing unit are adjacent to each other, do not overlap and form the sensing zone, so that the antenna modules can be disposed on the same layer. In this way, the electromagnetic touch device may be designed easily, and the costs may be reduced.

What is claimed is:

1. An electromagnetic touch device, adapted to cooperate with a signal generation unit, the electromagnetic touch device comprising:
a sensing unit, comprising a plurality of antenna modules which form a sensing zone, are adjacent to each other, do not overlap, and are used for receiving an electromagnetic signal generated by the signal generation unit to generate a plurality of electromagnetic sensing signals; and
a control unit, coupled to the antenna modules, for receiving the electromagnetic sensing signals, and according to intensities of the electromagnetic sensing signals, obtaining a location of the signal generation unit in the sensing zone.

2. The electromagnetic touch device according to claim 1, wherein the antenna modules are antenna coils.

3. The electromagnetic touch device according to claim 1, wherein the antenna modules are made of Indium Tin Oxide (ITO).

4. The electromagnetic touch device according to claim 1, wherein the control unit further comprises:
a switch unit, coupled to the antenna modules, for successively being coupled to the antenna modules according to a control signal, to output the corresponding electromagnetic sensing signals;
an operation amplifier, coupled to the switch unit, for receiving and amplifying the electromagnetic sensing signals; and
a microcontroller, coupled to the operation amplifier, for generating the control signal, and receiving the amplified electromagnetic sensing signals to calculate the location of the signal generation unit in the sensing zone.

5. The electromagnetic touch device according to claim 1, wherein the antenna modules are arranged as a matrix to form the sensing zone.

6. The electromagnetic touch device according to claim 1, wherein a quantity of the antenna modules in a horizontal direction is the same as a quantity of the antenna modules in a vertical direction.

7. The electromagnetic touch device according to claim 1, wherein a quantity of the antenna modules in a horizontal direction is different from a quantity of the antenna modules in a vertical direction.

8. An electromagnetic touch device, adapted to cooperate with a signal generation unit, the electromagnetic touch device comprising:
a sensing unit, comprising a plurality of enclosed antenna modules which form a sensing zone, are adjacent to each other, do not overlap each other, are used for receiving an electromagnetic signal, the signal generated by the generation unit, to generate a plurality of electromagnetic sensing signals; and
a control unit, coupled to the enclosed antenna modules, for receiving the electromagnetic sensing signals, and according to intensities of the electromagnetic sensing signals, calculating a location of the signal generation unit in the sensing zone.

9. The electromagnetic touch device according to claim 8, wherein the control unit further comprises:
a switch unit, coupled to the enclosed antenna modules, for successively being coupled to the enclosed antenna modules according to a control signal, so as to output the corresponding electromagnetic sensing signals;
an operation amplifier, coupled to the switch unit, for receiving and amplifying the electromagnetic sensing signals; and
a microcontroller, coupled to the operation amplifier, for generating the control signal, and for receiving the amplified electromagnetic sensing signals to calculate the location of the signal generation unit in the sensing zone.

10. The electromagnetic touch device according to claim 8, wherein the enclosed antenna modules are arranged as a matrix to form the sensing zone.
